(19) United States
(12) Patent Application Publication
(10) Pub. No.: US 2011/0248069 A1
(43) Pub. Date: Oct. 13, 2011

(54) ULTRASONIC WELD PAD FOR WELDING BATTERY CELL TABS

(75) Inventors: Alexander D. Khakhalev, Troy, MI (US); Paul F. Spacher, Rochester, NY (US); Jennifer Bracey, Holly, MI (US)

(73) Assignee: GM GLOBAL TECHNOLOGY OPERATIONS, INC., Detroit, MI (US)

(21) Appl. No.: 12/757,681

(22) Filed: Apr. 9, 2010

(51) Int. Cl. B23K 20/10

(52) U.S. Cl. 228/110.1; 228/1.1

(57) ABSTRACT

A weld pad for an ultrasonic welding horn for welding a battery cell tab is described. The weld pad includes a plurality of inner knurls having at least one sharp edge; and a plurality of outer knurls surrounding the plurality of inner knurls, the outer knurls being shorter than the inner knurls and having a rounded outer edge. A method of welding battery cell tabs using the weld pad is also described.

### BACKGROUND OF THE INVENTION

This invention relates generally to ultrasonic welding, and more particularly to a weld pad for ultrasonically welding battery cell tabs.

In ultrasonic welding, the ultrasonic welding tool typically includes an ultrasonic welding horn and an anvil. The ultrasonic welding horn applies pressure and transmits vibration energy to the materials to be bonded, which are supported by the anvil. Typically, the anvil is on the bottom and supports the channel material that is being welded to, for example an interconnect/bus bar. One or more cell tabs are placed on the bus bar, and the stack is placed in the welding tool. Prior to welding, the horn moves down and clamps the bus bar and cell tab(s) to the anvil. Under the clamping force, the bus bar is partially penetrated by the knurls of the anvil which holds the bus bar in position. The horn engages the cell tabs and provides motion on the surface of the bus bar. The motion of the parts under pressure generates significant heat and mechanically breaks the oxide films on the surface of both the bus bar and the cell tabs. As a result, mechanical and metallurgical bonding occurs. When the bonding is complete, the horn disengages from the cell tabs and the anvil disengages from the bus bar.

The welding horn and pad are typically designed for the particular application, although the welding tools could potentially be used for different applications. With plastics, ultrasonic welding causes local melting of the plastic due to absorption of vibration energy. With metals, the high pressure dispersion of surface oxides and local motion of the materials results in metal bonding, referred to here as welding.

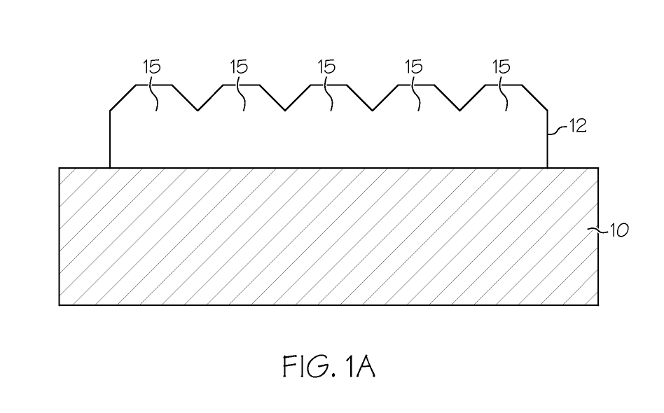

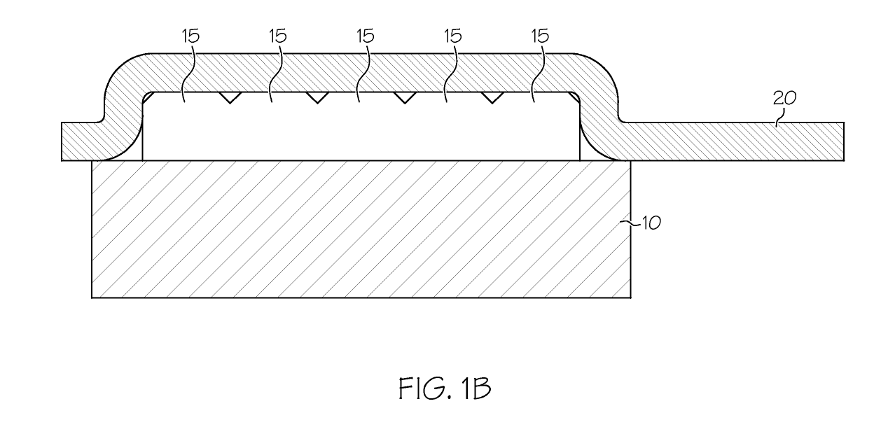

A prior art weld pad design for ultrasonic welding of battery cell tabs is shown in FIGS. 1A-B. Typically, one or more battery cell tabs are welded together and/or to a bus bar, for example. The horn 10 includes a weld pad 12 with knurls 15. All of the knurls 15 are the same height and shape (pyramid-shaped). The knurls have flat tops, and sharp corners. When a foil battery cell tab 20 is welded, there is foil deformation with a sharp transition at the outer edges because of the sharp corners on the knurls. In some cases, the sharp transition can result in perforations, cracks, and/or excessive deformation in the ultrasonic welds. If these defects occur, they can weaken the welds and degrade the long-term battery performance.

Therefore, there is a need for an improved weld pad design for ultrasonic welding of battery cell tabs which reduces weld defects.

### SUMMARY OF THE INVENTION

The present invention meets that need. In one embodiment, a weld pad for an ultrasonic welding horn for welding a battery cell tab is provided. The weld pad includes a plurality of inner knurls having at least one sharp edge; and a plurality of outer knurls surrounding the plurality of inner knurls, the outer knurls being shorter than the inner knurls and having a rounded outer edge.

In another embodiment, a method for ultrasonically welding a battery cell tab is provided. The method includes placing at least one battery cell tab on a weld pad, the weld pad comprising: a plurality of inner knurls having at least one sharp edge; a plurality of outer knurls surrounding the plurality of inner knurls, the outer knurls being shorter than the inner knurls and having a rounded outer edge; applying ultrasonic energy to the battery cell tab with an ultrasonic weld tool, the inner knurls supporting and holding the battery cell tab and the rounded outer edges of the outer knurls providing a smooth surface at the edge of the weld pad supporting the battery cell tab; and ultrasonically welding the battery cell tab.

### BRIEF DESCRIPTION OF THE INVENTION

FIGS. 1A-B are illustrations of a prior art weld pad and its use.

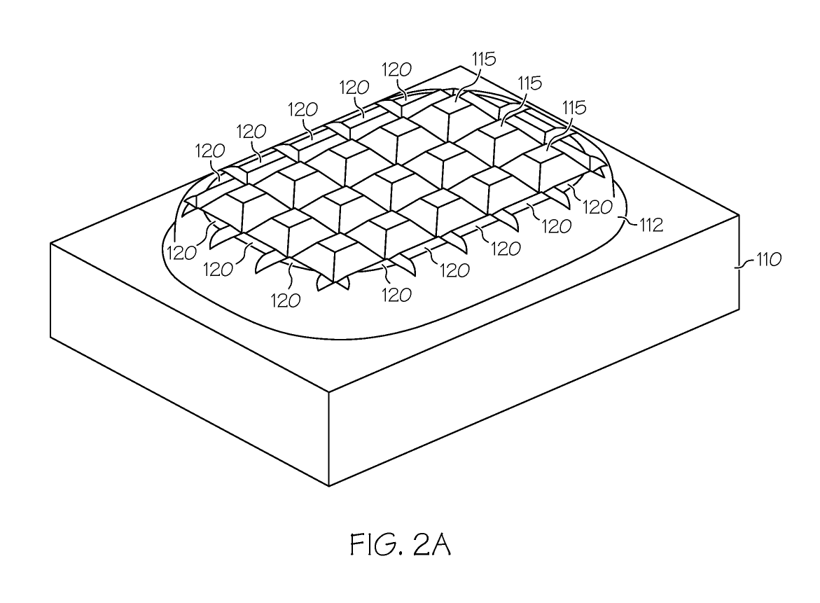

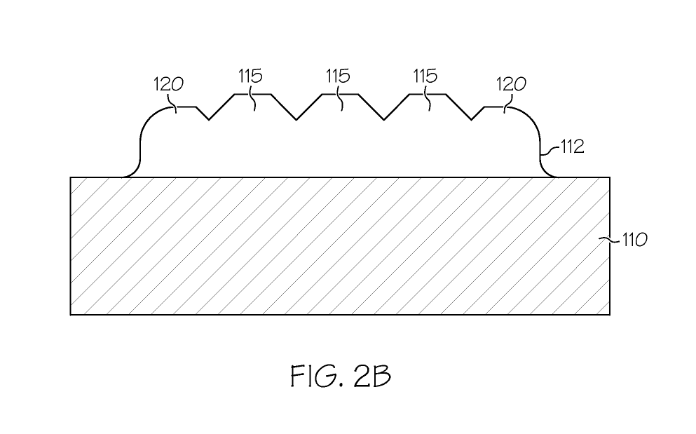

FIGS. 2A-B are illustrations of one embodiment of a weld pad design according to the present invention.

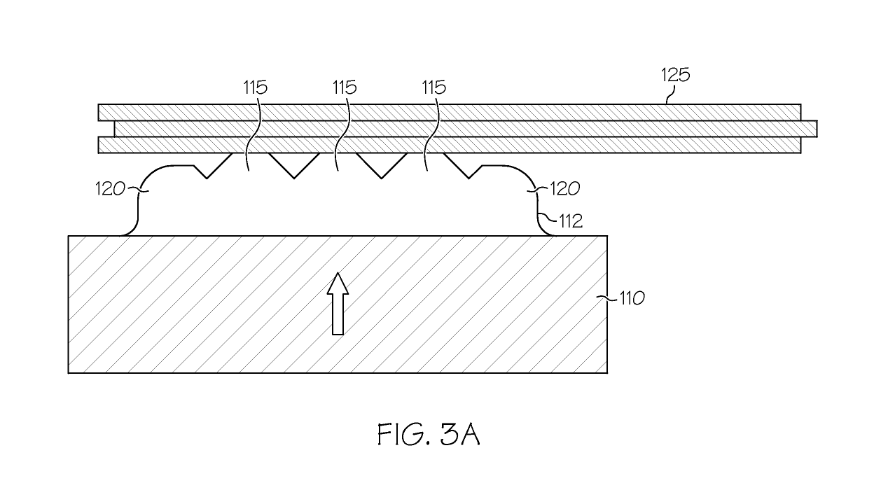

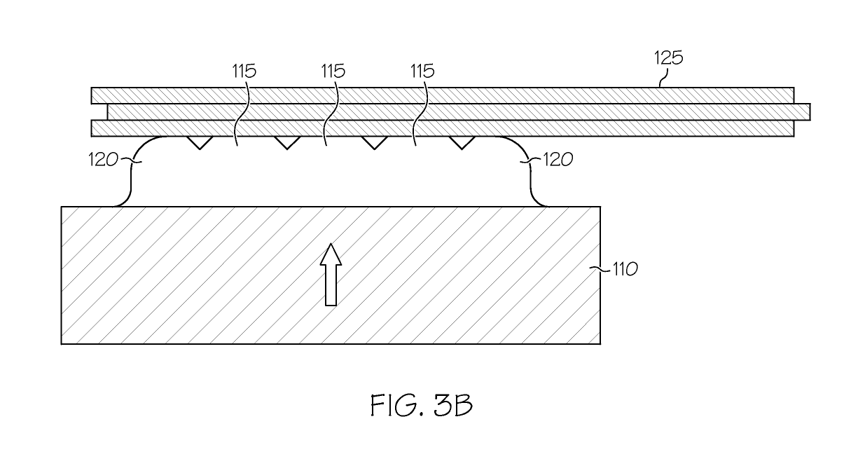

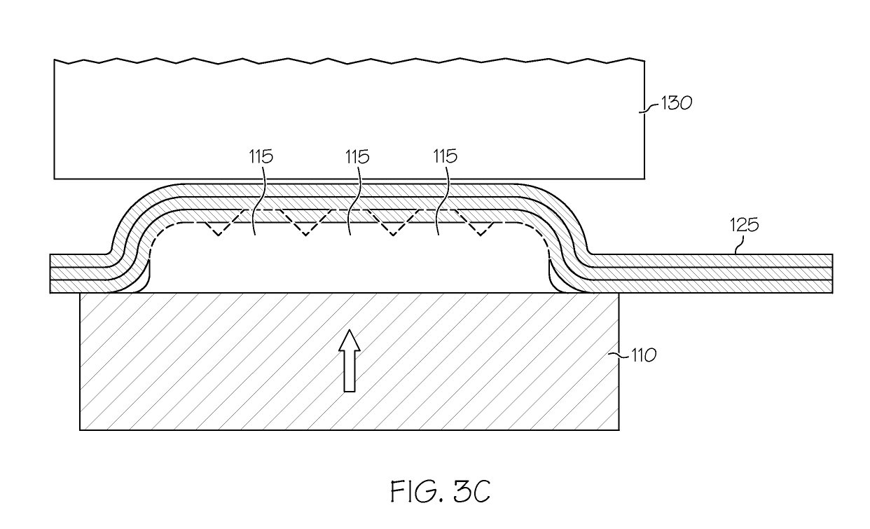

FIGS. 3A-C are illustrations of the use of the weld pad of FIG. 2.

### DETAILED DESCRIPTION OF THE INVENTION

The weld pad for battery tabs is designed to improve the weld quality of the battery cell tabs by minimizing tab deformation and crack formation, and by providing better metal interface bonding. It also improves the grip of the horn to the tabs and helps to minimize slippage in the coupled interface.

The weld pad has an optimized knurl pattern. There are a plurality of main inner knurls surrounded by a plurality of supporting outer knurls. The outer knurls are shorter than the inner knurls and have rounded outer edges. The inner knurls grab the tab foil, while the rounded edges of the outer knurls provide a smooth foil transition for the foils to go around during welding preventing them from being penetrated by the sharp edges of the inner knurls.

As shown in FIG. 2 (in inverted form), the horn 110 includes weld pad 112. The weld pad 112 has inner knurls 115 surrounded by outer knurls 120. The inner knurls 115 are pyramid-shaped and have sharp corners and flat tops. The outer knurls 120 are shorter than the inner knurls 115. They are pyramid-shaped, and the outside edges are rounded. The edges of the outer knurls which face the inner knurls or other outer knurls are sharp. Other shapes could be used for the inner and outer knurls provided they have the sharp edges and rounded edges in the appropriate positions as described above. The inner and outer knurls can be made of any suitable material, including, but not limited to, tool steel. These features of the inner and outer knurls 115, 120 provide smooth foil transition during welding, as shown in FIGS. 3A-C. The battery cell tabs 125 to be welded are placed on the welding pad 112 with the inner knurls 115 and outer knurls 120 as shown in FIG. 3A. The anvil 130 (FIG. 3C) exerts pressure on the battery cell tabs and/or bus bar 125 and the inner knurls 115 which compress, as shown in FIG. 3B. The battery cell tabs 125 are welded, and the rounded outer edges of the outer knurls provide a smooth foil transition.

The inner knurls provide a surface which grips and holds the tab foil, while the rounded edges of the outer knurls support the tab foil and provide a smooth transition for the tab foil around the weld pad. The rounded edges of the outer knurls prevent the tab foil from being penetrated by the sharp inner knurls. As a result, the welds formed using the optimized knurl pattern have low deformation, lower level of stress in the weld areas, and superior weld quality, leading to longer lasting welds and better battery performance.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise an electrochemical conversion assembly or fuel cell, a vehicle incorporating an electrochemical conversion assembly according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A weld pad for an ultrasonic welding horn for welding a battery cell tab comprising:
a plurality of inner knurls having at least one sharp edge;
a plurality of outer knurls surrounding the plurality of inner knurls, the outer knurls being shorter than the inner knurls and having a rounded outer edge.

2. The weld pad of claim 1 wherein the inner knurls have a flat top.

3. The weld pad of claim 1 wherein the outer knurls have a flat top.

4. The weld pad of claim 1 wherein the inner knurls are pyramid-shaped.

5. The weld pad of claim 1 wherein the outer knurls are pyramid-shaped.

6. The weld pad of claim 1 wherein the inner knurls have at least two sharp edges.

7. The weld pad of claim 1 wherein the outer knurls have at least one sharp edge.

8. The weld pad of claim 1 wherein the inner knurls are made of steel.

9. The weld pad of claim 1 wherein the outer knurls are made of steel.

10. A method for ultrasonically welding a battery cell tab comprising:
placing at least one battery cell tab on a weld pad, the weld pad comprising:
a plurality of inner knurls having at least one sharp edge;
a plurality of outer knurls surrounding the plurality of inner knurls, the outer
knurls being shorter than the inner knurls and having a rounded outer edge;
applying ultrasonic energy to the battery cell tab with an ultrasonic weld tool, the inner knurls supporting and holding the battery cell tab and the rounded outer edges of the outer knurls providing a smooth surface at the edge of the weld pad supporting the battery cell tab; and
ultrasonically welding the battery cell tab.

11. The method of claim 10 wherein the inner knurls have a flat top.

12. The method of claim 10 wherein the outer knurls have a flat top.

13. The method of claim 10 wherein the inner knurls are pyramid-shaped.

14. The method of claim 10 wherein the outer knurls are pyramid-shaped.

15. The method of claim 10 wherein the inner knurls have at least two sharp edges.

16. The method of claim 10 wherein the outer knurls have at least one sharp edge.

17. The method of claim 10 wherein the inner knurls are made of steel.

18. The method of claim 10 wherein the outer knurls are made of steel.

19. The method of claim 10 wherein the weld tool comprises an anvil and a horn with the weld pad thereon, further comprising clamping the anvil and horn on the battery cell tab.

20. The method of claim 19 wherein the anvil has a knurled surface.
